(19) United States
(12) Patent Application Publication
(10) Pub. No.: US 2010/0299255 A1
(43) Pub. Date: Nov. 25, 2010

(54) CASH REDEMPTION OF FUNDED PORTABLE CONSUMER TRANSACTION DEVICE WITHOUT PURCHASE TRANSACTION REQUIREMENTS

(76) Inventor: Nizam Antoo, San Carlos, CA (US)

Correspondence Address: Quarles & Brady LLP, TWO NORTH CENTRAL AVENUE, One Renaissance Square, PHOENIX, AZ, 85004-2391, US

(21) Appl. No.: 12/708,660

(22) Filed: Feb. 19, 2010

Related U.S. Application Data
(60) Provisional application No. 61/180,390, filed on May 21, 2009.

(51) Int. Cl. G06Q 20/00; G06Q 40/00; G06Q 30/00

(52) U.S. Cl. 705/41; 235/379; 705/44

(57) ABSTRACT

According to one implementation, a method is presented for redeeming cash from a funded Prepaid Portable Consumer Transaction Device (PPCTD) without conducting a purchase transaction in a payment processing apparatus. A first merchant at a first location receives a tender for deposit into an account having an identifier. A second merchant at a second location tenders a PPCTD corresponding to the account to a consumer in response to receiving the identifier from the consumer. In response to receiving from the consumer the tendered PPCTD and a request for substantially the full value in the account, the second merchant tenders substantially the full value of the account to the consumer. The second merchant makes the tender without requiring that the consumer conduct a purchase transaction for the sale of a good or service from the second merchant.

### BACKGROUND

The present invention relates generally to using a Prepaid Portable Consumer Transaction Device (PPCTD), and more particularly to using a PPCTD to redeem cash at a merchant location without conducting a transaction for the sale of a good or service with the merchant.

In many areas of the world, it is a novelty for a consumer to have a bank account, the banks are unreliable, the economic society lacks the capability to accept alternative forms of payment, and/or there is a limited ability for a consumer to withdraw funds for a bank once the consumer has deposit funds. For a consumer to send funds to family members or friends living in such “cash-and-carry” or “unbanked” environments, the consumer is typically limited to using a money courier service, such as the Western Union® money courier service. Not only is there a delay in the receipt of the money, but substantial transaction fees are incurred, often twenty percent (20%) or more of the amount of funds being sent by the money courier service.

Alternatively, cash or prepaid cards can be sent directly to family members. Neither of these methods, however, protect the sender if the money or card is stolen and each involves a substantial delay between the time the money or prepaid card is sent, and the time it is received. Further, in unbanked societies, only a few merchants may have the capability of accepting alternative forms of payment. The cardholder's options are limited to either shopping with those merchants capable of accepting alternative payment forms or purchasing an item or service, that they may or may not have otherwise bought, in order to receive cash back. If the prepaid card can be redeemed at a bank or ATM, the cardholder may then have to decide between incurring the cost of an unneeded transaction with a merchant in order to get cash-back from the merchant, or incurring the cost and inconvenience of waiting in long lines to use one of the area's few banks or ATMs.

Therefore, a way is needed to transfer funds to another individual without incurring substantial transaction fees. Further, there is a need for the individual to be able to access the funds as cash without incurring another transaction cost while still maintaining the security of cashless transfers for the sender.

### SUMMARY

In one implementation, a method is performed in a payment processing system in which a holder of a funded Prepaid Portable Consumer Transaction Device (PPCTD) redeems the PPCTD for cash at a merchant without conducting a purchase transaction with the merchant. The payment processing system is characterized by an account holder, a merchant, an issuer, a transaction handler, and an acquirer. Additionally, the merchant and account holder engage in a transaction upon an account that is associated with a PPCTD that has been issued by the issuer to the account holder. The merchant submits the transaction to the acquirer who forwards it for processing by the transaction handler. The transaction handler in turn requests that the issuer to obtain payment for the transaction from the account holder's account. The issuer forwards the payment to the transaction handler who forwards it to the acquirer to pay the merchant for the transaction.

The method of redeeming cash from a Prepaid Portable Consumer Transaction Device in the payment system further includes a merchant at a given location receiving a tender for deposit into an account and an identifier for the account. The account is issued by an issuer the Prepaid Portable Consumer Transaction Device (PPCTD). Further, when issued, the account is not associated with a monetary amount. Without the purchase of a sale of a good or service, a different merchant at another location, tenders the PPCTD corresponding to the account in response to receiving the identifier for the account. If instead receiving the PPCTD and a request for the full value in the account, the merchant tenders the full value of the account

In another implementation, a payment processing system is presented in which a merchant at a given location receives a tender in a first currency for deposit in an account issued by an issuer and corresponding to a PPCTD. The account does not have a monetary value prior to the deposit of the tender. The merchant further receives an identifier for the account. A different merchant at another location, without a purchase or sale of a good or service, tenders the PPCTD corresponding to the account if presented instead with the identifier for the account. If presented with the PPCTD and a request for the full value in the account, the merchant tenders the full value in the account. The tender is in a second currency, the first and second currencies being different. A transaction handler at different location then either of the merchants coordinates the repayment of the full value in the account to the second merchant by the first merchant through the merchants' respective acquirers.

In another implementation, a payment processing system is presented that includes a transaction handler, multiple merchants each having a corresponding acquirer, and multiple account holders each having accounts issued by a corresponding issuer. The payment processing system processes multiple transactions, each of which are characterized by a given merchant and account holder engaging in a transaction upon an account associated with a PPCTD that was issued to the account holder by the issuer. The transactions are further characterized by being processed by the same transaction handler. Each merchant in the payment processing system submits the transaction to their acquirer for processing by the transaction handler, who subsequently requests the issuer of the corresponding account obtain payment for the transaction from that account. The issuer forwards the payment to the transaction handler, who forwards it to the acquirer for payment to the merchant. Each merchant in the payment processing system has a means for receiving a tender for deposit into an account, not having a monetary value, issued by the issuer and corresponding to a PPCTD. Each merchant further has a means for receiving an identifier of the account. Additionally, each merchant has the means to, without a purchase or sale of a good or service, tender the PPCTD corresponding to the account upon receiving the account identifier or to tender the full value in the account upon receiving the PPCTD and a request for the full value in the account.

The foregoing and other objects and advantages of the inventions will appear in the detailed description that follows. In the description, reference is made to the accompanying drawings.

### BRIEF DESCRIPTION OF THE DRAWINGS

Implementations of the invention will become more apparent from the detailed description set forth below when taken in conjunction with the drawings, in which like elements bear like reference numerals.

FIG. 1 illustrates an exemplary payment processing network;

FIG. 2 illustrates an exemplary payment processing system for exchanging the value of a currency through the system for access by a card holder in the form of a cash redeemable Prepaid Portable Consumer Transaction Device (PPCTD);

FIGS. 3-4 depict flowcharts of respective exemplary processes for a user of a payment processing system to exchange the value of a currency through the payment processing system for access by a card holder in the form of a cash redeemable PPCTD; and

FIG. 5 illustrates an exemplary payment processing system wherein a user of a payment processing network exchanges the value of a currency in the form of a cash redeemable PPCTD.

### DETAILED DESCRIPTION

In one implementation, a funded Prepaid Portable Consumer Transaction Device (PPCTD) is redeemed for cash from a merchant without making a purchase transaction from the merchant. In an alternative of this implementation, the redemption utilizes a payment processing system to transfer funds from one individual to another in real time and preferably with minimum transaction fees.

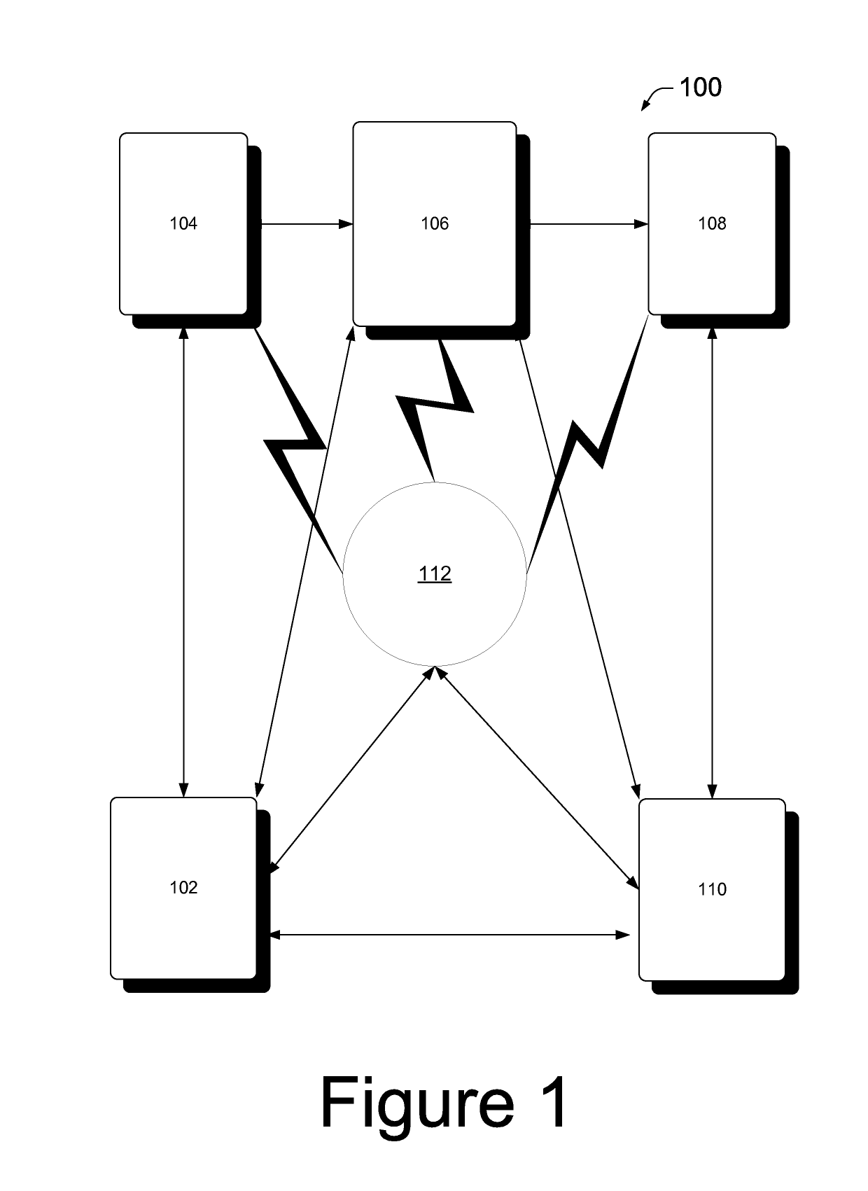

FIG. 1 illustrates an exemplary payment processing network. In general, a transaction includes participation from different entities that are a component of a payment processing system 100, including an user 102, such as an account holder (e.g.; the consumer associated with the account), a transaction handler 106, such as a credit card company, an acquirer 108, a merchant 110, and an issuer 104. Acquirer 108 and issuer 104 can communicate through transaction handler 106. Merchant 110 may be a person or entity that sells goods or services. Merchant 110 may also be, for instance, a manufacturer, a distributor, a retailer, a load agent, a drugstore, a grocery store, a gas station, a hardware store, a supermarket, a boutique, a restaurant, or a doctor's office. In a business-to-business setting, the user 102 may be a second merchant making a purchase from another merchant 110. Merchant 110 may utilize at least one point-of-sale (POS) terminal that can communicate with acquirer 108, transaction handler 106, or issuer 104. Thus, the POS terminal is in operative communication with the payment processing system 100.

Typically, a transaction begins with user 102, such as an account holder or a consumer, presenting a PPCTD 112 to merchant 110 to initiate an exchange for a good or service. The PPCTD 112 may include a payment card, a gift card, a smartcard, a smart media, a payroll card, a health care card, a wrist band, a machine readable medium containing account information, a keychain device such as a SPEEDPASS® device commercially available from ExxonMobil Corporation or a supermarket discount card, a cellular phone, personal digital assistant, a pager, a security card, an access card, a wireless terminal, or a transponder. The PPCTD 112 may include a volatile or non-volatile memory to store information such as the account number or an account holder's name.

Merchant 110 may use the POS terminal to obtain account information, such as an account number, from the PPCTD 112. The PPCTD 112 may interface with the POS terminal using a mechanism including any suitable electrical, magnetic, or optical interfacing system such as a contactless system using radio frequency or magnetic field recognition system or contact system such as a magnetic stripe reader. The POS terminal sends a transaction authorization request to the issuer 104 of the PPCTD 112. Alternatively, or in combination, the PPCTD 112 may communicate with issuer 104, transaction handler 106, or acquirer 108.

Issuer 104 may authorize the transaction using transaction handler 106. Transaction handler 106 may also clear the transaction. Authorization includes issuer 104, or transaction handler 106 on behalf of issuer 104, authorizing the transaction in connection with issuer 104's instructions such as through the use of business rules. The business rules could include instructions or guidelines from transaction handler 106, user 102, merchant 110, acquirer 108, issuer 104, a financial institution, or combinations thereof. Transaction handler 106 may maintain a log or history of authorized transactions. Once approved, merchant 110 will record the authorization, allowing user 102 to receive the good or service.

Merchant 110 may, at discrete periods, such as the end of the day, submit a list of authorized transactions to acquirer 108 or other components of the payment processing system 100. Transaction handler 106 may compare the submitted authorized transaction list with its own log of authorized transactions. If a match is found, transaction handler 106 may route authorization transaction amount requests from the corresponding acquirer 108 to the corresponding issuer 104 involved in each transaction. Once acquirer 108 receives the payment of the authorized transaction amount from issuer 104, it can forward the payment to merchant 110 less any transaction costs, such as fees. If the transaction involves a debit or pre-paid card, acquirer 108 may choose not to wait for the initial payment prior to paying merchant 110.

There may be intermittent steps in the foregoing process, some of which may occur simultaneously. For example, acquirer 108 can initiate the clearing and settling process, which can result in payment to acquirer 108 for the amount of the transaction. Acquirer 108 may request from transaction handler 106 that the transaction be cleared and settled. Clearing includes the exchange of financial information between the issuer 104 and the acquirer 108 and settlement includes the exchange of funds. Transaction handler 106 can provide services in connection with settlement of the transaction. The settlement of a transaction includes depositing an amount of the transaction settlement from a settlement house, such as a settlement bank, which transaction handler 106 typically chooses, into a clearinghouse, such as a clearing bank, that acquirer 108 typically chooses. Issuer 104 deposits the same from a clearinghouse, such as a clearing bank, which issuer 104 typically chooses, into the settlement house. Thus, a typical transaction involves various entities to request, authorize, and fulfill processing the transaction.

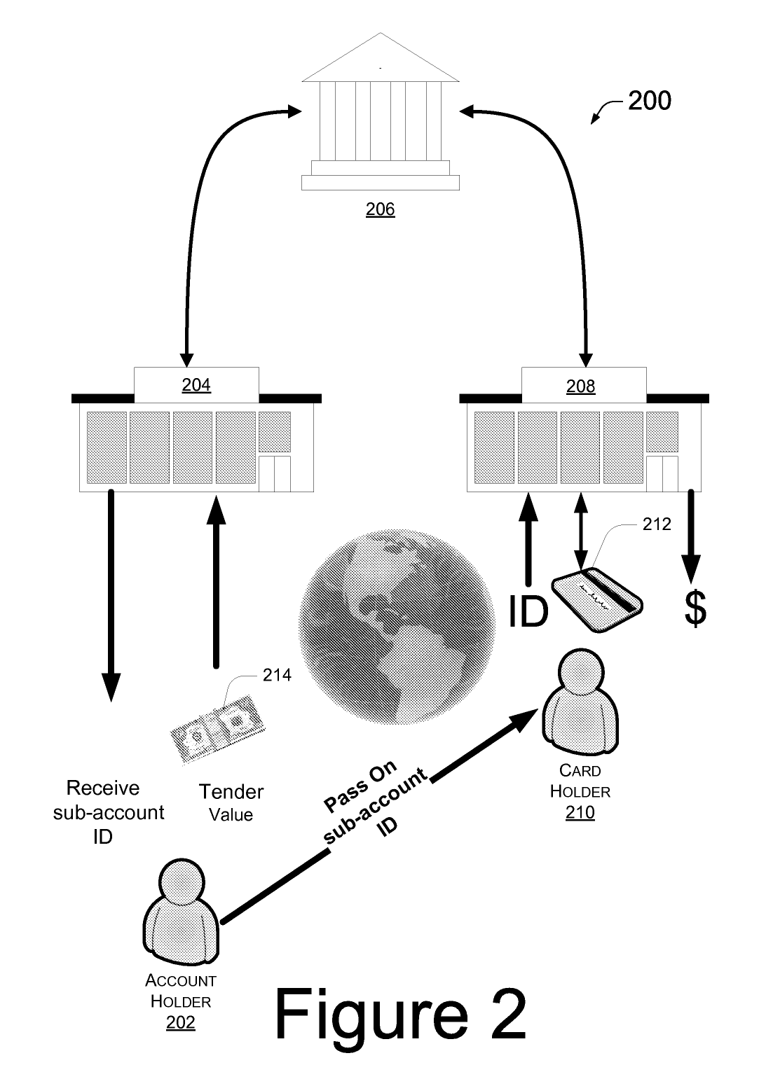

FIG. 2 illustrates an exemplary payment processing system 200 for exchanging the value of a currency through the system via a PPCTD. From a broad perspective, merchant 204 receives a tender of value 214 from account holder 202 (e.g.; cash, bank check, cashier check, withdrawal from a deposit account, cash drawn on a revolving credit account) Tender 214 is to be deposited into an account (i.e., a sub-account of the account holder 202's account) that has been issued by an issuer (e.g., potentially the issuer of the sub-account and the account holder 202's account are the same issuer) and corresponds to a PPCTD. Prior to the deposit of funds 214 into the account, the account substantially has no value in it (e.g.; it can be a newly issued account). Merchant 204 may be, for example, a bank or other financial institution or a vendor of goods and services. Additionally, merchant 204 may specialize in transferring funds using PPCTDs (e.g., a currency exchange and check cashing merchant).

In one implementation, account holder 202 pays merchant 204 the tend 214 for deposit into an account issued by an issuer. The tender 214 can be taken from an account held by the account holder 202, such as the account holder 202's PPCTD. In yet another implementation, account holder may provide to merchant 204 an account identifier of an account having a value for the tender 214. To pay for the deposit amount, account holder 202 may use, for example, a credit card, a prepaid card, or other alternative form of payment, or a combination thereof, instead of, or in addition to, making a cash payment. In additional implementations, account holder may also have the tender 214 made by direct deposits to the account from, for example, a paycheck or other account.

For security, access privileges to the account itself may be restricted, by for example, individual names, associated PPCTDs, or any other identifier, or combination thereof. Thus, for example, although the account holder may have opened the account, they may not have access to funds once they've been deposited. Further, withdrawals from the account can be limited to specific individuals or to specific PPCTDs, regardless of the individual holding the card.

Merchant 204 forwards the tender 214 of the deposit amount and the account identifier to payment processing system 206 where merchant 204's acquirer forwards it to the transaction handler for processing. The transaction handler then forwards a request to the issuer to deposit of the tender 214 in the account corresponding to the account identifier (i.e., a sub-account ID). In another implementation, the account may be issued but not yet be activated and a request for activation may also be sent from merchant 204 to payment processing system 206 where merchant 204's acquirer forwards the request for activation to the transaction handler for processing. The transaction handler forwards the request to the issuer for the issuer to activate the account to contain the tender 214.

In one implementation, account holder 202 gives the sub-account ID to a cardholder 210 who gives the sub-account ID to another merchant 208. Merchant 208 verifies the identity of cardholder 204, if acceptable, merchant 208 gives a PPCTD 212 corresponding to the sub-account to the cardholder 210. The cardholder 210 can access the funds 214 in sub-account, without making a purchase from merchant 208, by tendering the PPCTD 212 back to the merchant 208 (or to another merchant (not shown). Upon receipt by merchant 208 of the tendered PPCTD 212, merchant 208 will tender to cardholder 210 substantially the full value of the sub-account corresponding to PPCTD 212. Again, the tender of value by merchant 208 to cardholder 210 is performed without requiring that cardholder 210 conduct a purchase transaction (i.e., to pay additional value for the purchase and sale of goods or services in a transaction) with merchant 208.

When once tender 214 is deposited into the account corresponding to PPCTD 212, cardholder 210 will have access to substantially all of the value of the tender 214 in the account. Alternatively, access may be delayed, for example, to approve the transfer of funds or the activation of the account corresponding to the PPCTD 212. Cardholder 210, in some implementations, may be the same individual as account holder 202. In other implementations, cardholder 210 may be a different individual, who may be located in another city or country (i.e., the location where the tender 214 is given is different than where the PPCTD 212 is tendered). Cardholder 210 may be notified by account holder 202 that funds have been deposited by a telephone call, email, letter, or any other form of communication or combination thereof. During this notification, cardholder 210 will further be notified by account holder 202 of the sub-account ID corresponding to the PPCTD 212.

As stated above, in one implementation, cardholder 210 may receive the PPCTD 212 corresponding to the account into which the tender 214 was deposited from merchant 208 after providing merchant 208 with the account identifier for the account associated with PPCTD 212. In some implementations cardholder 210 may further need to activate PPCTD 212 prior to using it to receive cash, the activation process associating the PPCTD 212 with the account. By way of example, and not by way of limitation, the activation process may include calling a telephone number, sending an email, providing an access code given to cardholder 210 by account holder 202, showing identification, giving identifying information, or a combination thereof. Alternatively, in another implementation, account holder 202 or the issuer of the account corresponding to the PPCTD 212 may send cardholder 210 the PPCTD 212 associated with the account.

In response to merchant 208 receiving from cardholder 210 the PPCTD 212 and a request for substantially all of the funds from the account associated with the PPCTD, merchant 208 forwards a request for authorization of the tender to payment processing system 206 where it is received by merchant 208's acquirer. The acquirer forwards it to the transaction handler who forwards the request to the issuer of the account for approval. In yet another implementation, cardholder 210 may not use a PPCTD to receive cash from merchant 208, instead providing an account identifier to merchant 208.

In one implementation, payment processing system 206 provides authorization when requested of substantially the full amount in the account corresponding to the PPCTD 212. Alternatively, a partial authorization may be returned if, for example, the request exceeded the funds in the account or cardholder 210 exceeded a predefined limit.

Upon approval of the request for funds from the account, merchant 208 tenders cash to cardholder 210 without cardholder 210 making a purchase for the sale of a good or service from merchant 208. The cash tendered may, in some implementations, be in a different currency than the currency of the tender 214 used by account holder 202 to make the deposit into the account corresponding to PPCTD 212.

In some implementations, the PPCTD 212 is a card capable of communicating information to a point-of-sale (POS) device via a magnetic stripe. In other implementations the PPCTD 212 is also a smart card and may have a contact area comprising electrical contacts. And in yet other implementations, the PPCTD communicates wirelessly.

Along with the PPCTD 212, cardholder 210 may be required, for example, to show merchant 208 identification or provide identifying information. Where access to the account is restricted, this information may be forwarded to payment processing system 206 and compared with information associated with the account before cash is dispersed to cardholder 210. As with merchant 204, merchant 208 may be, for example, a bank or other financial institution or a vendor of goods and services. Additionally, merchant 208 may specialize in transferring funds using PPCTDs. Merchant 208 then sends a request to payment processing system 206 seeking authorization to payout substantially the full amount in the account corresponding to the PPCTD 212. Alternatively, the authorization may be for substantially all funds in the account or a portion thereof.

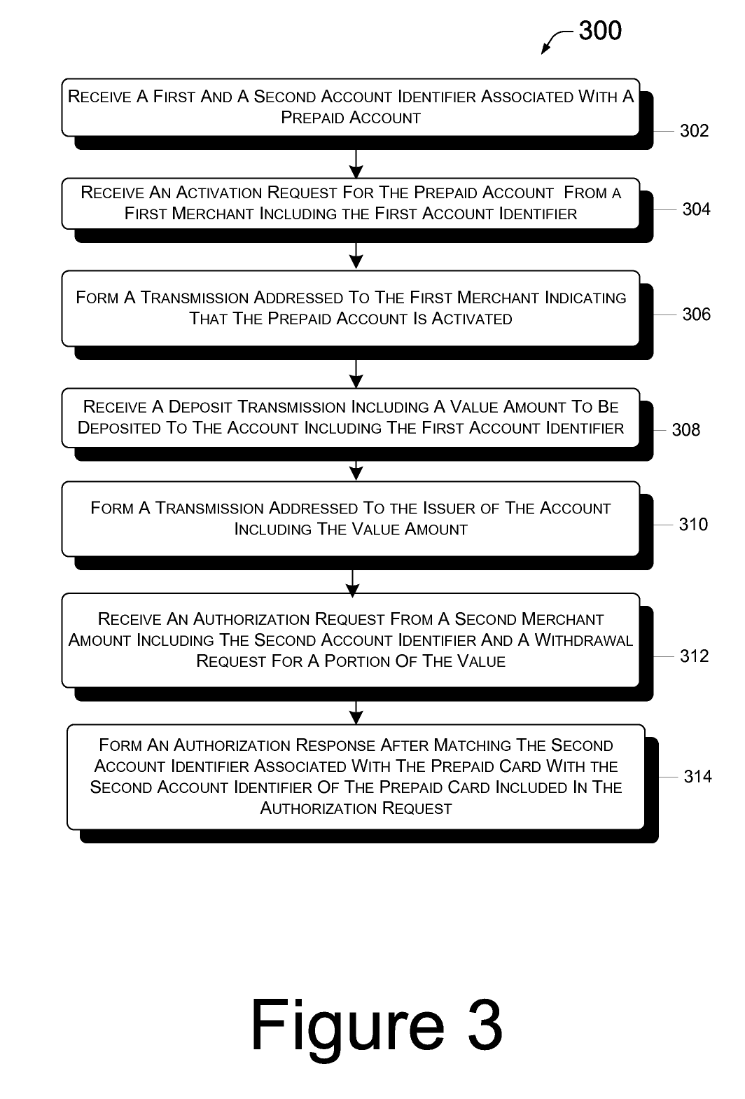

FIG. 3 provides a flowchart of an exemplary process 300 of a use of a PPCTD from the perspective of a transaction handler. The transaction handler receives two account identifiers associated with a prepaid account (step 302), the account identifiers being different in some implementations, and an activation request for the account (step 304) from a merchant. In addition to being associated with the same account, each identifier is associated with a different PPCTD and each PPCTD is held by different cardholders. In alternative implementations, only one of the account identifiers is associated with a PPCTD held by a cardholder. Additionally, the cardholder may further be different from the account holder.

Using the account identifiers, the transaction handler identifies the account to the issuer for approval or denial of the activation. Assuming the issuer approves, in step 306 the transaction handler forms a transmission to the merchant indicating the account is activated. Next, in step 308, a deposit transmission is received from the merchant, containing the amount to be deposited into the account and the identifier of the account, and the transmission is forwarded to the issuer in step 310. In step 312, the transaction handler then receives an authorization request from another merchant that includes the withdrawal amount and the second account identifier. In alternative implementations, the merchant may be the same entity as the merchant who sent the activation request. Finally, in step 314, the transaction handler compares the identifier sent with the authorization request with those sent with the activation request and, if there is a match, the transaction handler authorizes the withdrawal amount.

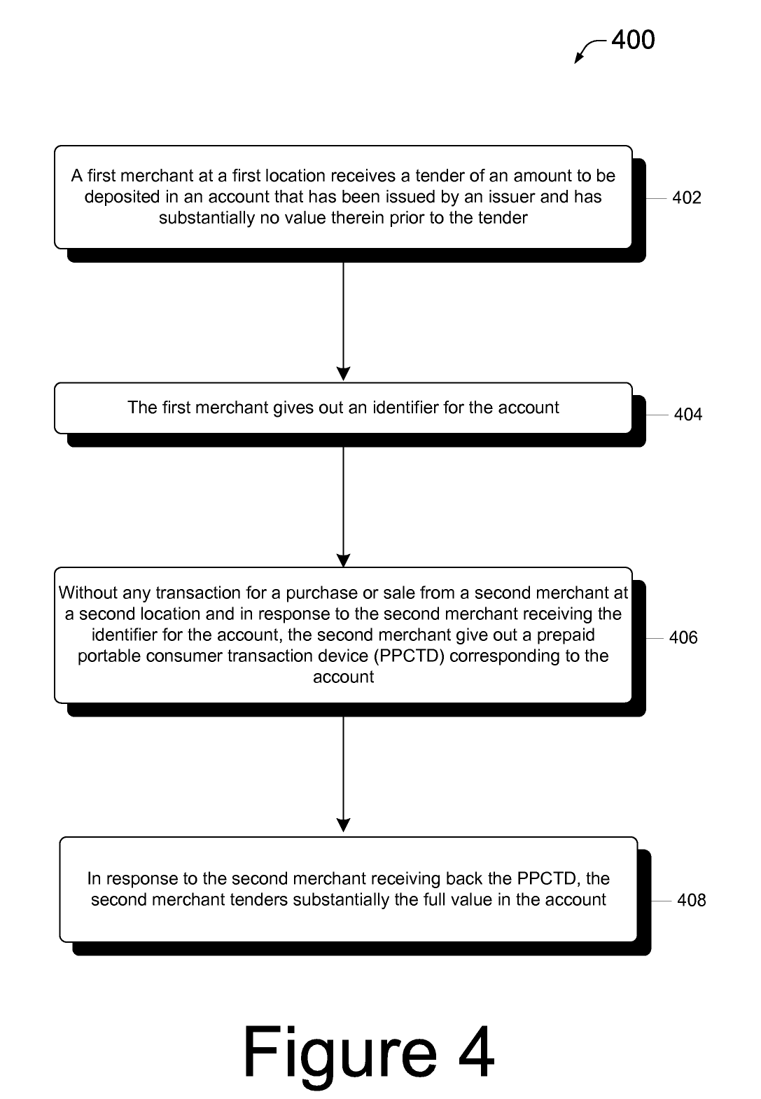

FIG. 4 provides a flowchart of an exemplary process 400 of a use of a PPCTD from the perspective of two (2) merchants.

At a step 402, a first merchant at a first location receives a tender of an amount to be deposited in an account that has been issued by an issuer and has substantially no value therein prior to the tender.

At a step 404, the first merchant gives out an identifier for the account. At a step 406, without any transaction for a purchase or sale from a second merchant at a second location and in response to the second merchant receiving the identifier for the account, the second merchant give out a prepaid portable consumer transaction device (PPCTD) corresponding to the account.

At a step 408, in response to the second merchant receiving back the PPCTD, the second merchant tenders substantially the full value in the account. As such, the tender of currency to the first merchant is given out by the second merchant to the one from whom the second merchant consecutively receives the identifier for the first account and its corresponding PPCTD that the second merchant gives in response to the second merchant receiving the identifier for the first account.

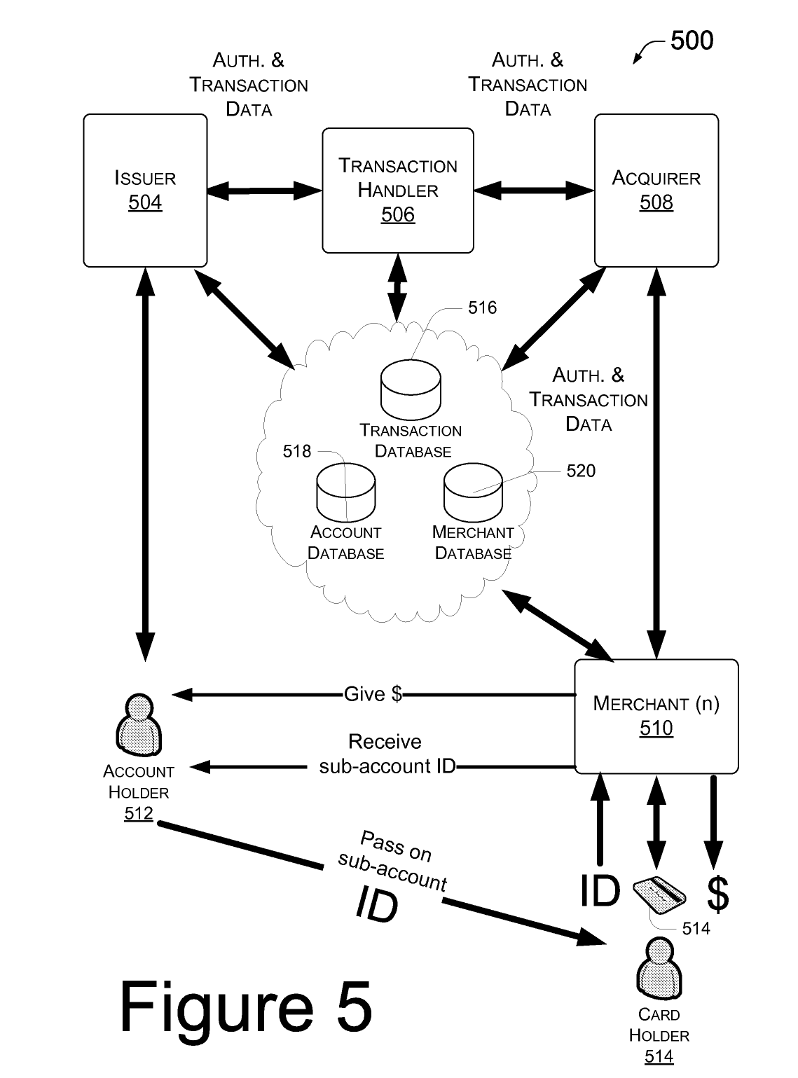

FIG. 5 illustrates an exemplary payment processing network 500 wherein a user of the payment processing network 500 exchanges the value of a currency with first merchant in the form of a PPCTD that is substantially redeemable for cash at a second merchant in potentially a different currency without requiring the user to make a purchase from the second merchant. To start, a given merchant 510(n), receives a tender from an account holder 502. Typically the tender is cash. However, in other implementations the tender may be a PPCTD, check, or other method of transferring funds, or combination thereof. Merchant (n) 510 gives an account identifier of an account into which a deposit the tender will be made, the account having been issued by issuer 504.

The transaction of the foreign tender is processed by payment processing network 500 similarly to the process previously described in connection with FIG. 1. Merchant (n) 510 submits the transaction to its acquirer 508. Where acquirer 508 is not also the same entity as issuer 504, acquirer 508 forwards the transaction information to a transaction handler 506, who in turn forwards it to issuer 504 for deposit into the account. The account holder 502 provides to a card holder 514 the account identifier of the account into which the deposit of the tender was made.

Thereafter, Merchant (N) 510 then receives from the cardholder 512 the account identifier of the account into which the deposit of the tender was made. Merchant (N) 510, in some implementations, may be a different from merchant (n) 510 and may be located in another location which uses different currency. Further, cardholder 512 may be a different entity then account holder 502. Upon receipt of the account identifier, merchant (N) 510 may provide a PPCTD 514 associated with the account identified to cardholder 512, which is provided to cardholder 512 without requiring that cardholder 512 purchase a good or service from merchant (N) 510. In some implementations, to provide the PPCTD 514, cardholder 512 may be required to provide identifying information in the form of a driver's license, passport, password, or other identifier, or combination thereof. Merchant (N) 510 may additionally forward the identifying information to acquirer 508 for processing by transaction handler 506. Transaction handler 506 forwards the information to the issuer 504 of the account for approval of the transaction and will forward issuer 504's response to acquirer 508 to then be forwarded to merchant (N) 510. Assuming approval, the transaction is not stopped but rather proceeds.

Upon merchant (N) 510 receiving back from cardholder 512 both the PPCTD 514 and a request for substantially the cash value from the associated account, merchant (N) 510 tenders substantially the full value in the account in cash to cardholder 512 without merchant (N) 510 requiring cardholder 512 to purchase a good or service from merchant (N) 510. Alternatively, the cash value may not be for the full monetary amount associated with the account. Merchant (N) 510 may further provide information regarding the requested cash value to acquirer 508 to be forwarded to transaction handler 506 for processing. Transaction handler 506 requests that issuer 504 of the account provide payment for the requested cash value. Issuer 504 then forwards this payment to transaction handler 506, who forwards it to acquirer 508 for payment to merchant 510.

The various steps or acts in a method or process may be performed in the order shown, or may be performed in another order. Additionally, one or more process or method steps may be omitted or one or more process or method steps may be added to the methods and processes. An additional step, block, or action may be added in the beginning, end, or intervening existing elements of the methods and processes. Based on the disclosure and teachings provided herein, a person of ordinary skill in the art will appreciate other ways and/or methods for various implements.

The present invention can be implemented in the form of control logic, in a modular or integrated manner, in software or hardware or a combination of both. Thus, the steps of a method, process, or algorithm described in connection with the implementations disclosed herein may be embodied directly in hardware, in a software module executed by a processor, or in a combination of the two. The control logic may be stored in an information storage medium as a plurality of instructions adapted to direct an information processing device to perform a set of steps disclosed in embodiment of the present invention. Based on the disclosure and teachings provided herein, a person of ordinary skill in the art will appreciate other ways and/or methods to implement the present invention.

The software components or functions described in this application, may be implemented as software code to be executed by hardware, such as one or more processors, using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may also reside on or within a single computational apparatus, and may be present on or within different computational apparatuses within a system or network.

Any recitation of “a”, “an” or “the” is intended to mean “one or more” unless specifically indicated to the contrary.

The present invention may be embodied in other specific forms without departing from its spirit or essential characteristics. The described implementations are to be considered in all respects only as illustrative and not restrictive. The scope of the invention should, therefore, be determined not with reference to the above description, but instead should be determined with reference to the pending claims along with their full scope or equivalents, and all changes which come within the meaning and range of equivalency of the claims are to be embraced within their full scope.

what is claimed is:

1. In a payment processing system for a plurality of transactions each characterized by a merchant and an account holder engaging in the transaction upon an account associated by a consumer transaction device that an issuer issues to the account holder where a transaction handler processes the transaction for both the merchant and for other said transactions for other said merchants, each said merchant submitting the corresponding said transaction to a corresponding acquirer for processing by the transaction handler who requests the issuer of the corresponding said account to obtain payment for the corresponding said transaction from the corresponding said account and for which the issuer forwards the payment to the transaction handler who forwards the payment to the acquirer to pay the merchant for the corresponding said transaction, a method comprising a plurality of steps each being performed by hardware executing software, wherein the steps include:
receiving at a first said merchant at a first location:
a tender to be deposited in a first said account, wherein the first said account:
has been issued by one said issuer; and
has substantially no value therein prior to the tender
and
tendering an identifier for the first said account by the first said merchant at the first location:
and
without any said transaction for a purchase or sale from a second said merchant at a second location different from the first location and in response to the second said merchant receiving:
the identifier for the first said account, the second said merchant tendering a first Prepaid Portable Consumer Transaction Device (PPCTD) corresponding to the first said account; and
the tendered first PPCTD and a request for substantially a full value in the first said account, the second said merchant tendering substantially the full value in the first said account.

2. The method as defined in claim 1, wherein the tender for deposit in the first account is in a first currency different than the tender of the full value in the first said account which is in a second currency different from the first currency.

3. The method as defined in claim 1, wherein the steps further comprise receiving the tendered deposit and the identifier:
at a first said acquirer of the first said merchant;
at the transaction handler from the first said acquirer; and
at the issuer of the first said account for deposit in the first said account from the transaction handler.

4. The method as defined in claim 3, wherein the steps further comprise:
receiving a request for repayment of the tendered deposit:
at a second said acquirer for the second said merchant;
at the transaction handler from the second said acquirer; and
at the issuer of the first said account corresponding to the first PPCTD;
and
receiving the repayment of the tendered deposit:
at the transaction handler from the issuer of the first said account; and
at the second said acquirer for the second said merchant from the transaction handler for deposit in one said account of the second said merchant.

5. The method as defined in claim 1, wherein the steps further comprise:
receiving a request for activation of the first said account:
at a first said acquirer of the first said merchant;
at the transaction handler from the first said acquirer; and
at the issuer of the first said account for activation of the first said account from the transaction handler.

6. The method as defined in claim 1, wherein the steps further comprise:
receiving a request for authorization of the tender of the full value in the first account from the second said merchant:
at a second said acquirer of the second said merchant;
at the transaction handler from the second said acquirer; and
at the issuer of the first said account for authorization of the tender of the full value of the first said account from the transaction handler.

7. The method as defined in claim 1, wherein the steps further comprise the second said merchant receiving an authorization means prior to the second said merchant tendering the first PPCTD, wherein the authorization means is a member of the group consisting of:
a government identification card;
a passport;
an access code;
a password; and
a biometric identifier.

8. The method as defined in claim 1, wherein the first said merchant receives the tender to be deposited in the first said account from a first entity and the second said merchant tenders the full value in the first said account to a second entity, the first and second entities being different.

9. The method as defined in claim 1, wherein the steps further comprise:
receiving at the first said merchant:
a subsequent tender to be deposited in the first said account; and
the identifier for the first said account;
and
without the purchase or the sale of the good or service from the second said merchant and in response to the second said merchant receiving the first PPCTD and a request for a subsequent full value in the first said account, the second said merchant tenders the subsequent full value in the first account.

10. The method as defined in claim 1, wherein in response to receiving the tender for deposit in the first account that corresponds to the first PPCTD, the first said merchant tenders a second PPCTD corresponding to the first account.

11. Any payment processing apparatus in which:
a first merchant apparatus at a first location, which by hardware executing software, receives:
a tender in a first currency for deposit in a first account that:
has been issued by an issuer; and
has substantially no value therein prior to the tender;
the first merchant apparatus at the first location tenders an identifier for the first account;
a second merchant apparatus at a second location, which by hardware executing software, without a transaction for a purchase or sale from the second merchant apparatus, in response to receipt of:
the identifier for the first account, tenders a PPCTD corresponding to the first account; and
the tendered PPCTD and a request for substantially a full value in the first account, tenders substantially the full value in the first account in a second currency different from the first currency;
and
a transaction handler at a third location, which by hardware executing software, coordinates the repayment of substantially the full value in the first account to the second merchant apparatus by the first merchant apparatus through respective acquirers of the first merchant apparatus and the second merchant apparatus.

12. The payment processing apparatus as defined in claim 11, wherein the tender for deposit in the first account is in a first currency different than the tender of the full value in the first account which is in a second currency different from the first currency.

13. The payment processing apparatus as defined in claim 11, wherein the payment processing apparatus processes a plurality of transactions each characterized by one said merchant and an account holder engaging in the transaction for a purchase or sale of a good or service from the one said merchant upon one said account associated with one said PPCTD that an issuer issues to the account holder where a transaction handler processes the transaction for both the one said merchant and for other said transactions for other said merchants, each said merchant submitting the corresponding said transaction to a corresponding said acquirer for processing by the transaction handler who requests the issuer of the corresponding said account to obtain payment for the corresponding said transaction from the corresponding said account and for which the issuer forwards the payment to the transaction handler who forwards the payment to the acquirer to pay the merchant for the corresponding said transaction.

14. The payment processing apparatus as defined in claim 13, wherein a request for activation of the first account is received:
at a first said acquirer from the first merchant;
at the transaction handler from the first said acquirer; and
at the issuer of the first account from the transaction handler.

15. The payment processing apparatus as defined in claim 13, wherein a request for authorization of the tender of substantially the full value in the first account from the second merchant is received:
at a second said acquirer from the second merchant;
at the transaction handler from the second said acquirer; and
at the issuer of the first account from the transaction handler.

16. The payment processing apparatus as defined in claim 11, wherein the identifier for the first account received by the second merchant prior to the second merchant tendering the PPCTD further comprises an identity token selected from the group consisting of:
a government identification card;
a passport;
an access code;
a password; and
a biometric identifier; and
a combination of the forgoing.

17. The payment processing apparatus as defined in claim 11, wherein the first merchant apparatus receives the tender to be deposited in the first said account from a first entity and the second merchant apparatus tenders substantially the full value in the first account to a second entity, the first and second entities being different.

18. A payment processing apparatus comprising:
a transaction hander apparatus;
a plurality of merchant apparatuses each having a corresponding acquirer apparatus;
a plurality of account holders each having an account issued by a corresponding issuer, wherein the payment processing apparatus processes, by hardware executing software, a plurality of transactions each characterized by:
one said merchant and one said account holder, by hardware executing software, engaging in the transaction upon said account associated with a PPCTD that one said issuer issues to the one said account holder; and
the transaction handler apparatus, by hardware executing software, processes the transaction both for the one said merchant and for other said transactions for other said merchants;
wherein each said merchant apparatus, by hardware executing software, submits the corresponding said transaction to its corresponding acquirer for processing by the transaction handler who requests the issuer of the corresponding said account to obtain payment for the corresponding said transaction from the corresponding said account and for which the issuer forwards the payment to the transaction handler who forwards the payment to the corresponding acquirer to pay the merchant for the corresponding said transaction;
each said merchant apparatus having:
means for receiving:
a tender to be deposited in a first said account that:
has been issued by one said issuer; and
has no value therein prior to the tender;
and
an identifier for the first said account;
and
means, without any said transaction for a purchase or sale from the merchant apparatus and in response to the merchant apparatus receiving:
the identifier for the first said account, for tendering a PPCTD corresponding to the first said account; and
the tendered PPCTD and a request for substantially a full value in the first said account, for tendering substantially the full value in the first said account.

19. The payment processing apparatus as defined in claim 18, wherein the tender to be deposited in the first said account is in a first currency different than the tender of the full value in the first said account which is in a second currency different from the first currency.

20. The payment processing apparatus as defined in claim 18, further comprising means for receiving the tendered deposit and the identifier:
at the acquirer apparatus corresponding to the merchant apparatus;
at the transaction handler apparatus from the acquirer apparatus corresponding to the merchant apparatus; and
at the issuer of the account for deposit in the account from the transaction handler apparatus.

21. The payment processing apparatus as defined in claim 18, further comprising:
means for receiving the request for repayment of the tendered deposit:
at the acquirer apparatus corresponding to the merchant apparatus;
at the transaction handler apparatus from the acquirer apparatus corresponding to the merchant apparatus; and
at the issuer of the first said account corresponding to the PPCTD;
and
means for receiving the repayment of the tendered deposit:
at the transaction handler apparatus from the issuer of the first said account; and
at the acquirer apparatus corresponding to the merchant apparatus from the transaction handler apparatus for deposit in an account corresponding to the merchant apparatus.

22. The payment processing apparatus as defined in claim 18, further comprising means for requesting for activation of the first said account, wherein the request for activation is received:
at an acquirer apparatus corresponding to the merchant apparatus;
at the transaction handler apparatus from the acquirer apparatus; and
at the issuer of the first said account from the transaction handler apparatus.

23. The payment processing apparatus as defined in claim 18, further comprising means for requesting authorization of the tender of substantially the full value in the first said account from the merchant apparatus, wherein the request for authorization is received:
at an acquirer apparatus corresponding to the merchant apparatus;
at the transaction handler apparatus from the acquirer apparatus; and
at the issuer of the first said account from the transaction handler apparatus.

24. The payment processing apparatus as defined in claim 18, further comprising the merchant apparatus receiving an identification token prior to the merchant apparatus tendering the PPCTD, wherein the identification token is selected from the group consisting of:
a government identification card;
a passport;
an access code;
a password;
a biometric identifier; and
a combination of the forgoing.

25. The payment processing apparatus as defined in claim 18, wherein the merchant apparatus receives the tender to be deposited in the first said account from a first entity and the merchant apparatus tenders substantially the full value in the first said account to a second entity, the first and second entities being different.
